(19) United States
(12) Patent Application Publication
(10) Pub. No.: US 2024/0086216 A1
(43) Pub. Date: Mar. 14, 2024

(54) PRIORITIZING TASKS OF AN APPLICATION SERVER

(71) Applicant: INTERNATIONAL BUSINESS MACHINES CORPORATION, ARMONK, NY (US)

(72) Inventors: Philip I Wakelin, (US); Michael D. Brooks, Southampton (US); Alan Hollingshead, Eastleigh (US); Mark James Hiscock, Eastleigh (US)

(21) Appl. No.: 17/930,734

(22) Filed: Sep. 9, 2022

(51) Int. Cl. G06F 9/455; G06F 9/50

(52) U.S. Cl. CPC G06F 9/45558; G06F 9/5038

(57) ABSTRACT

A method, system, computer program product and a computer program for prioritizing queued tasks waiting to access a resource associated with a resource manager in an application server, wherein an incoming task received at the application server from a calling application may have a status indicating that the incoming task is in a final phase during which a response to the calling application is created, the method comprising: receiving the incoming task; identifying the status of the incoming task; in response to identifying that the status of the incoming task is in the final phase, placing the incoming task in a priority queue; analyzing any queued tasks waiting to access the resource in the priority queue and one or more other queues; and processing a queued task from the priority queue in preference to the one or more other queues.

### BACKGROUND

The present invention relates generally to task management, and more particularly to prioritizing tasks in an application server.

The ability to schedule tasks, or requests, is a key component of managing throughput in application servers. An application server receives a task from a calling application and sends a response back to the calling application after processing the task. The application server includes resource managers that manage and communicate with multiple resources that may be required to process the task. Resources can include CPU, memory and network resources. The application server can receive multiple tasks and therefore, there are usually multiple tasks that are competing for the use of shared resources.

In a typical request/response transaction model, a task goes through various processing phases. The task may start with an initialization phase, which may include setting up parameters, obtaining storage and installing resource definitions. In a business logic phase, the business logic programs and algorithms of the task are processed. This phase is also known as the “in-flight” phase or the “dynamic” phase. Once the business logic phase is complete, a response is returned to the calling application in the final phase. The final phase is also known as the “commit” phase. In the final phase of a task, the response is built, ready to be sent by the application server back to the calling application. By way of example, the response may contain a status code, which indicates the request has been successfully completed and/or the response may include a body that includes data associated with the request. Both the business logic phase and the final phase require access to various resources. The processing of a task may also include the allocation of resources, such as storage, network connections and other limited resources.

In a one-thread system, in response to receiving a task from a calling application, a thread is constructed. The task is allocated to the thread and processed. Once the task has finalized the response, it provides the response back to the calling application. A “blocking” task can stop the task processing cycle for a significant amount of time. This can happen if the application server is waiting to access a resource, or it may be busy with a lengthy, CPU-intensive task.

While processing such “blocking” tasks, the application server cannot start other tasks, even though there are more system resources available that other tasks in the queue could utilize. For example, reading from a disk is a slow process, and other tasks on the queue that do not need to read from the drive are forced to wait. This results in system latencies and resources not being concurrently used. This leads to an unresponsive application server that appears to have frozen while it is processing the “blocking” task. Application servers that are waiting on the blocking task to complete will also appear to have frozen.

Thread pooling allows concurrent processing of tasks. The thread pool maintains multiple threads which are created at startup. Each thread waits for a task to be assigned to it, processes the task, and goes back to waiting for the next task. The thread pooling design avoids the costly thread construction and destruction functions for every task that requires processing. Thread pooling can move “blocking” tasks to a worker thread that runs concurrently to a main thread, such that the application remains responsive to input.

There are drawbacks of thread pooling. “Thread starvation” occurs when a thread can't gain access to a shared resource and therefore cannot progress. Shared resources can be made unavailable by “greedy” threads that require heavy utilization of the shared resource, which leads to longer waiting and processing times.

A task may need to access multiple resources to provide a response to the calling application. A task will require access to resources when processing its business logic, as well as performing the final return of data to the calling application. Issues can arise when a newer task starts using a resource that an older task, that has finished its business logic, requires and thus the older task must wait until the newer task has finished. This may happen if, for example, the old task did not require access to the shared resource before its final phase, but requires the shared resource in its final phase. This slows down the overall throughput of tasks in application server, as tasks that have almost completed are not drained from the thread pool.

### SUMMARY

According to one embodiment a method for prioritizing queued tasks waiting to access a resource associated with a resource manager in an application server, wherein an incoming task received at the application server from a calling application includes a status indicating that the incoming task is in a final phase during which a response to the calling application is created is provided. The embodiment may include receiving an incoming task. The embodiment may further include identifying a status of the incoming task. The embodiment may also include, in response to identifying that the status of the incoming task is in a final phase, placing the incoming task in a priority queue. The embodiment may further include analyzing any queued tasks waiting to access the resource in the priority queue and one or more other queues. The embodiment may also include processing a queued task from the priority queue in preference to the one or more other queues.

In conventional methods, resource managers may include a single queue of tasks. Two incoming first and second tasks, which are running on separate threads, may both be contending for the same, shared resource. Conventionally, if the resource is in use by different task, any such incoming tasks are placed in the single queue of tasks. This means that the first and second task will be placed in the single queue in the order in which they request the resource associated with the resource manager. They both sit in the single queue, waiting for the resource to become available. As such, the second task, irrespective of its processing phase, will be processed after processing of the first task has been completed.

Advantageously, the present invention takes the processing phase associated with tasks into account. This means that if the second task is in its final phase, then that task will be placed in a priority queue and will be processed in preference to tasks on other queues. Processing the second task from the priority queue before the first task (which is on a non-priority ‘other’ queue) results in the thread pool being drained more rapidly, leading to a faster and more efficient concurrent system. This is because the tasks that are placed in the priority queue are in their final phase, and are ready to create a response, to send back to the calling application.

In embodiments, the present invention provides a method, wherein the incoming task may have a status indicating that the incoming task in another phase.

Advantageously, having a separate, higher priority queue to distinguish tasks that are other phases with tasks that are in their final phase allows the resource to process the prioritized tasks first. This results in an application server that can process and drain tasks in a fast and efficient manner.

In embodiments, the present invention provides a method further including: in response to identifying that the status of the incoming task is in the another phase, placing the incoming task in one of the one or more other queues.

Advantageously, by using the processing phase of the task as the prioritization factor, tasks that are ready to respond to the calling application, i.e., that are in their final phase, will not need to wait for newer tasks that contend for the same resource to complete. The task that is ready to respond to the calling application will be processed first, and the tasks in the other queue will subsequently be processed in the order they were received by the resource. It will be appreciated that the resource manager may comprise more than one “other” queues.

In embodiments, the present invention provides a method, wherein the application server further includes a resource flow processor for monitoring the state of the incoming task and wherein the method further comprises marking the incoming task according to its processing phase.

The resource flow processor allows the statuses of the tasks to be marked according to their processing phase, such that the resource managers can place the tasks into the appropriate queue (i.e. into the priority or the at least one other queue). The placing of the tasks in the different queues allows the method to process tasks in an efficient way.

In embodiments, the present invention provides a method, wherein the application server further includes a thread pool for managing and allocating the processing of the incoming task.

In embodiments, the present invention provides a method, wherein the incoming task and the queued task that is processed from the priority queue are identical. In embodiments, the present invention provides a method, wherein the incoming task and the queued task that is processed from the priority queue are different.

In embodiments, the present invention provides a method, wherein the final phase of the first task denotes when the task has completed its business logic phase.

Advantageously, using the processing phase of the task as the prioritization factor, tasks that are ready to respond to the calling application will not need to wait for newer tasks that contend for the same resource to complete. The task that is ready to create a response to the calling application will be processed first, and the tasks in the at least one other queue will subsequently be processed in the order they were received by the resource.

In embodiments, the present invention provides a method, wherein the processing the queued task includes allocating the resource associated with the resource manager.

Viewed from another aspect, the present application provides a system for prioritizing queued tasks waiting to access a resource associated with a resource manager in an application server, wherein an incoming task received at the application server from a calling application includes a status indicating that the incoming task is in a final phase during which a response to the calling application is created, the system including: a task queue; a thread pool; a resource flow processor; and at least one resource manager for managing communication between the application server and a resource, a processing device; and a memory coupled to the processing device and storing instructions that, when executed by the processing device, cause the system to perform operations including: receiving an incoming task; identifying a status of the incoming task; in response to identifying that the status of the incoming task is in a final phase, placing the incoming task in a priority queue; analyzing any queued tasks waiting to access the resource in the priority queue and one or more other queues; and processing a queued task from the priority queue in preference to other queues.

Viewed from another aspect, the present application provides a computer program stored on a computer readable medium and loadable into the internal memory of a digital computer, including software code portions, when said program is run on a computer, for prioritizing queued tasks waiting to access a resource associated with a resource manager in an application server, wherein an incoming task received at the application server from a calling application may have a status indicating that the incoming task is in a final phase during which a response to the calling application is created.

### DESCRIPTION OF THE DRAWINGS

The present invention will now be described, by way of example only, with reference to preferred embodiments, as illustrated in the following figures:

FIG. 1 illustrates, in accordance with an embodiment of the present invention, a system wherein an application server receives a request, or a task, from a calling application;

FIG. 2 illustrates, in accordance with an embodiment of the present invention, a timeline of two tasks that share a resource;

FIG. 3 illustrates, in accordance with an embodiment of the present invention, a timeline of three tasks that share a resource;

FIG. 4 is a block diagram depicting the hardware components of a system for prioritizing queued tasks waiting to access a resource associated with a resource manager in an application server;

FIG. 5 is a functional block diagram depicting a cloud computing environment, in accordance with an embodiment of the invention; and

FIG. 6 is a diagram depicting abstraction model layers provided by the cloud computing environment of FIG. 4, in accordance with an embodiment of the invention.

### DETAILED DESCRIPTION

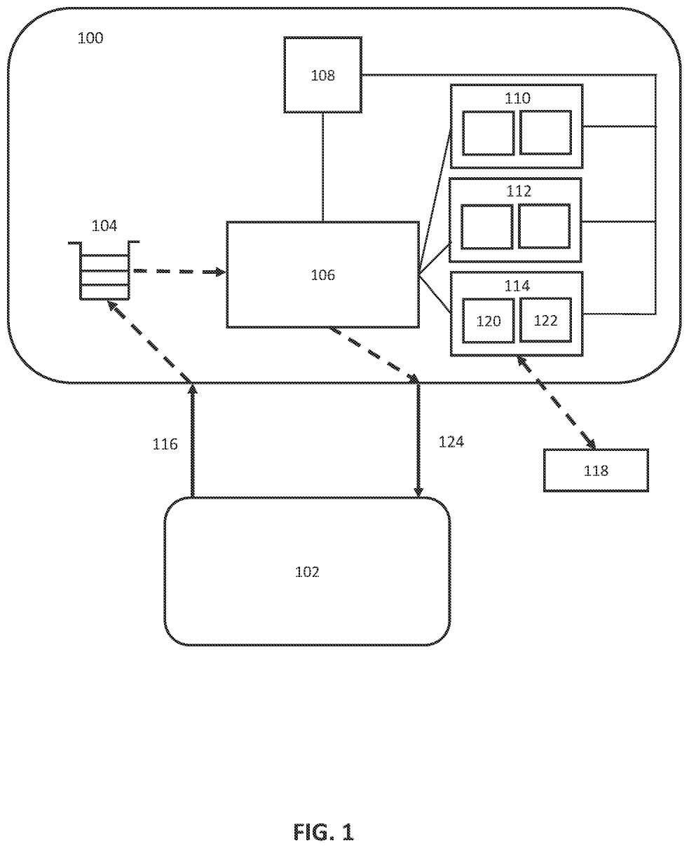

Referring to FIG. 1, an application server 100 is in communication with a calling application 102. The application server 100 comprises a task queue 104, a thread pool 106, a resource flow processor (RFP) 108 and multiple resource managers (RMs) 110, 112, 114. The RFP 108 is connected to the thread pool 106, as well as each of the RMs 110, 112, 114. Each RM is connected to a corresponding resource and manages the task scheduling and communication between the resource and the application server.

The resources connected to RM 110 and 112 are not shown. RM 114 is connected to a resource 118. The person skilled in the art will appreciate that there may be many threads in the thread pool, and many resources connected by RMs, in communication with the application server.

The RFP continuously monitors the state of the tasks in each thread and marks the task according to its processing phase. A task goes through various processing phases, including the business logic phase and the final phase. The RFP holds a record of the processing phases of each task and provides the states of the processing phases to the RMs querying the processing phase status of a particular task. When a task in a thread has completed its business logic phase and enters the final phase, the RFP marks the task as being in its final phase, for example, marking it as “final_send”.

It should be appreciated that the resource and the RM can be called by a task at different stages of the task's processing phase. For example, a task may request access to a resource during its business phase and the final phase. In another example, the task may only require the resource during its final phase. A task may, for example, request access to resource 118 during its business logic processing phase. Upon completion of this phase, it will release the resource, thereby making it available to other tasks. The task may then move into its final phase of processing and may request access to the same or a different resource.

Multiple tasks that are running on different threads, and that are in different processing phases, may request access to a same resource. This means that they are all contending for the same resource and must wait for the resource to become available. Conventional RMs prioritize tasks by the order in which they request the resource. The present method prioritizes tasks depending on their processing phase. Tasks that request a resource in their final phase are prioritized before other tasks that request access to the contentious resource during their business logic phase.

The RMs in the present method comprise at least two queues for giving tasks access to the resource associated with that RM; one priority queue and at least one other queue. The tasks that request access to the resource before reaching their final phase are placed in a queue other than the priority queue. The tasks that request access to the resource during their final phase are placed in the priority queue. This ensures that the tasks that are in their final phase are processed first, resulting in threads in the thread pool being drained in an efficient manner. The prioritization is facilitated by an analysis step, wherein the resource manager analyses the priority queue and any other queues in the RM to determine which queued task should be processed next.

In the embodiment illustrated in FIG. 1, the application server 100 receives 116 a task from a calling application 102. The task is placed in the task queue 104. When a thread in the thread pool 106 becomes idle, the task is allocated to said thread and the thread starts processing the task. In the final phase of the task, the RM 114 is called to manage the resource 118 required by the task. When the RM is called by the task, the RM queries the RFP to check the status of the task.

If the status of the task is not in its final state, the task is placed in a other queue 120. If the status of the task is in its final state, the task is placed in a priority queue 122. Tasks that are still processing their business logic are placed in the other queue 120. The priority queue 122 is the higher priority queue, where the tasks placed in this queue are processed by the RM first. Only tasks that are in their final phase are placed in the priority queue 122.

When the RM completes the processing of a task and is ready to process the next task, it processes the tasks that are in the priority queue 122 first, before processing the tasks on the other queue 120. Once the task finishes its business logic phase as well as its final phase, the resulting response is sent back 124 to the calling application.

This ensures that tasks that are in their final states and needing a contentious resource can be given priority; a task's processing phase is used as the prioritization factor. The tasks that are ready to form the response are processed first, resulting in threads in the thread pool being drained in an efficient manner.

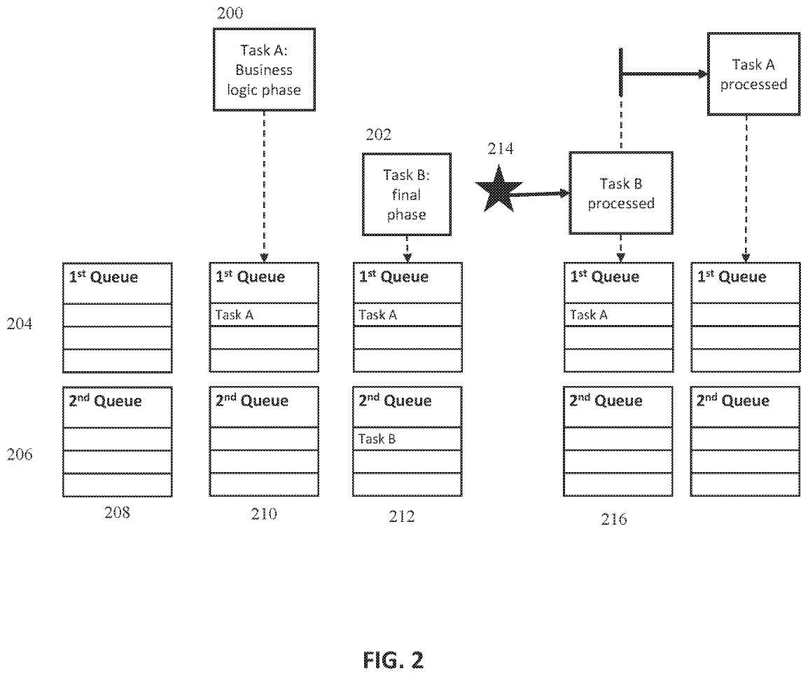

FIG. 2 shows, in accordance with a preferred embodiment, the different stages of a RM's two queues along an illustrative timeline. Task A 200 and Task B 202 both require the use of a shared resource (not shown). The shared resource has two queues associated with it: an other queue 204, and a priority queue 206. At the start of this example, the shared resource is already processing a previous task (not shown), such that all new tasks must be placed on a queue. There are no tasks 208 on both queues of the RM.

Task A calls the RM during its business logic phase 210. As the resource is in use, the resource cannot process Task A straight away. The RM queries the RFM to identify that Task A is not in its final state, and therefore is placed 210 in the other queue 204.

Task B calls the RM during its final state. In this example, Task B did not require access to the resource during its business logic phase. The RM queries the RFM to identify that Task B is in its final phase, and places 212 task B in the priority queue 206.

Once the shared resource finishes processing the previous task (not shown) 214, it processes the task that is in the high priority queue 206, before processing the tasks in the other queue 204. Once Task B has been processed 216, the RM processes Task A, since the there are no tasks waiting in the priority queue 206.

Task B is therefore processed before Task A by the RM, since Task B completed its business logic first. This means that Task B, which is almost ready to respond back to the calling application, can be dealt with and removed from the thread pool. This allows other tasks to be allocated to the thread pool and results in a more efficient application server.

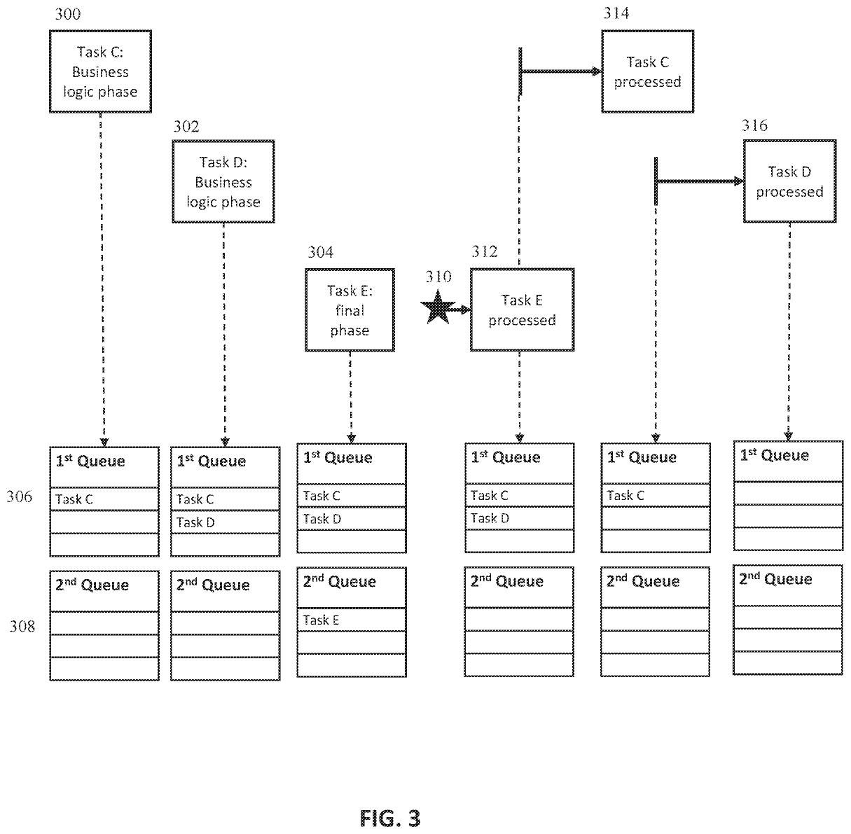

FIG. 3 shows another example of the queues of a RM (not shown), shared by Task C 300, Task D 302 and Task E 304, along an illustrative timeline. The shared resource is already processing a previous task (not shown), such that all new tasks must be placed on a queue.

Task C calls the RM during its business logic phase 300. As the resource is in use, the resource cannot process Task C straight away. The RM queries the RFP about the state of the task. As it is in its business logic phase, the RM places Task C into the first, other queue 306. It will be appreciated that Task C may be in a state other than the business logic phase, but not yet in the final phase.

Task D calls the RM during its business logic phase 302. As the resource is in use, the resource cannot process Task D straight away. The RM queries the RFP about the state of the task. As the task is in its business logic phase, the RM places Task D into the first, other queue 306.

Task E calls the RM during its final phase 304. In this example, Task E did not require access to the resource during its business logic phase. As the resource is in use, the resource cannot process Task E straight away. The RM queries the RFP about the state of the task. As the task is in its final phase, the RM places Task D into the second, priority queue 308.

Once the resource finishes processing the previous task (not shown) 310, the RM looks at the tasks in the priority queue to select a task to process next. Task E is in the priority queue, so the resource starts to process Task E. When Task E has been processed 312, the RM looks at the tasks in the priority queue. There are no tasks waiting in the priority queue. Thus, the RM looks at the tasks waiting in the other queue. It identifies Task C as next in line, and thus the resource starts to process Task C. Once Task C has been processed 314, the RM identifies that Task D is next in line. Finally, Task D is processed 316.

In this embodiment, although Tasks C and D called the resource before Task E, Task E is prioritized and processed first, due to its final phase status. This means that Task E, which is almost ready to respond back to the calling application, can be dealt with and removed from the thread pool. This allows other tasks to be allocated to the thread pool and results in a more efficient application server.

As may be used herein, the terms “substantially” and “approximately” provide an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may also be used herein, the terms “processing system”, “processing module”, “processing circuit”, “processor”, and/or “processing unit” may be used interchangeably and may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing system, processing module, module, processing circuit, and/or processing unit may be, or further include, memory and/or an integrated memory element, which may be a single memory device, a plurality of memory devices, and/or embedded circuitry of another processing system, processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing system, processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing system, processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry including the state machine, analog circuitry, digital circuitry, and/or logic circuitry. Still further note that, the memory element may store, and the processing system, processing module, module, processing circuit, and/or processing unit executes, hard coded and/or operational instructions corresponding to at least some of the steps and/or functions illustrated in one or more of the Figures. Such a memory device or memory element can be included in an article of manufacture.

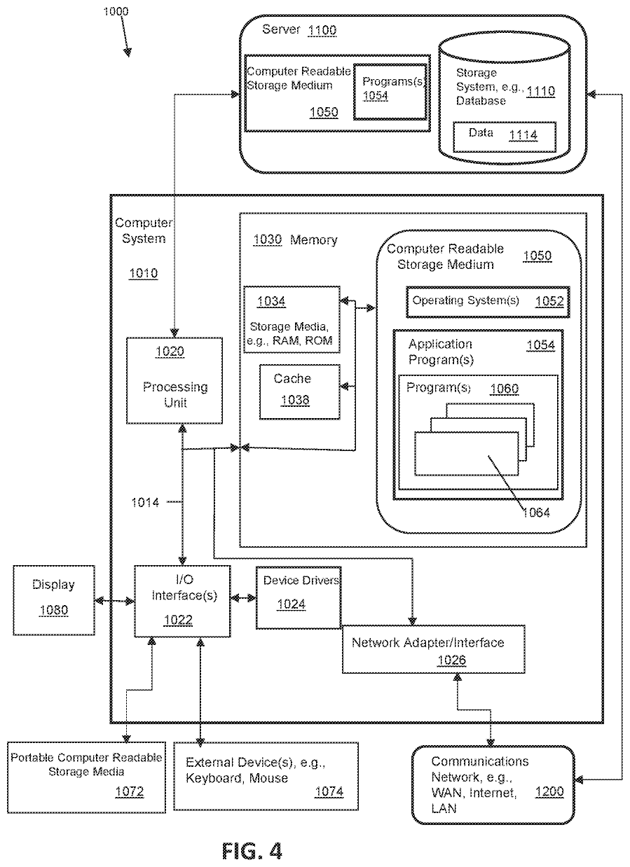

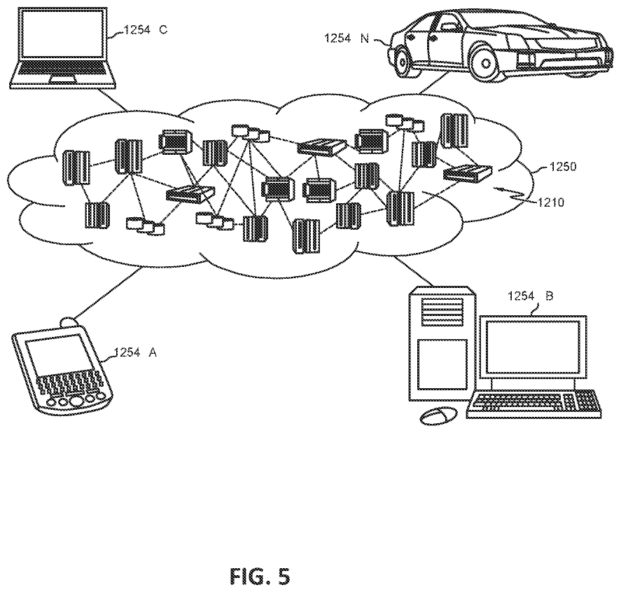

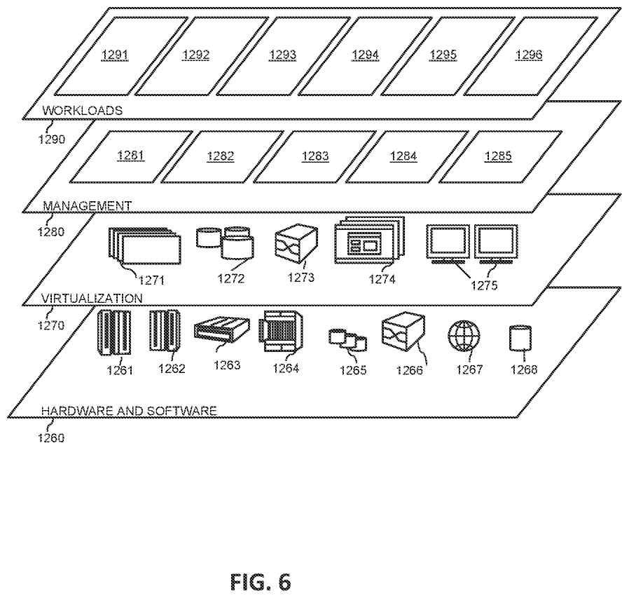

The system described in the present invention may include internal and external hardware components, as described in further detail below with respect to FIG. 4. It should be appreciated that FIG. 4 provides only an illustration of one implementation and does not imply any limitations with regard to the environments in which different embodiments may be implemented. Many modifications to the depicted environment may be made. In other embodiments, system described in the present invention may operate in a cloud computing environment, as depicted in FIGS. 5 and 6.

Referring to FIG. 4, a system 1000 includes a computer system or computer 1010 shown in the form of a generic computing device. The method of the present invention, for example, may be embodied in a program(s) 1060 (FIG. 4) embodied on a computer readable storage device, for example, generally referred to as memory 1030 and more specifically, computer readable storage medium 1050 as shown in FIG. 4. For example, memory 1030 can include storage media 1034 such as RAM (Random Access Memory) or ROM (Read Only Memory), and cache memory 1038. The program 1060 is executable by the processing unit or processor 1020 of the computer system 1010 (to execute program steps, code, or program code). Additional data storage may also be embodied as a database 1110 which can include data 1114. The computer system 1010 and the program 1060 shown in FIG. 4 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in FIG. 4 as program modules 1064. The program 1060 and program modules 1064 can execute specific steps, routines, sub-routines, instructions or code, of the program.

Embodiments of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, as shown in FIG. 4, the system 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media 1034 in the form of volatile memory, such as random access memory (RAM), and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method of the present invention, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The program 1060 may be the keyword system 104 or the natural language processing system 106. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 1250 is depicted. As shown, cloud computing environment 1250 includes one or more cloud computing nodes 1210 with which local computing devices used by cloud consumers, such as, for example, personal digital assistant (PDA) or cellular telephone 1254A, desktop computer 1254B, laptop computer 1254C, and/or automobile computer system 1254N may communicate. Nodes 1210 may communicate with one another. They may be grouped (not shown) physically or virtually, in one or more networks, such as Private, Community, Public, or Hybrid clouds as described hereinabove, or a combination thereof. This allows cloud computing environment 1250 to offer infrastructure, platforms and/or software as services for which a cloud consumer does not need to maintain resources on a local computing device. It is understood that the types of computing devices 1254A-N shown in FIG. 5 are intended to be illustrative only and that computing nodes 1210 and cloud computing environment 1250 can communicate with any type of computerized device over any type of network and/or network addressable connection (e.g., using a web browser).

Referring now to FIG. 6, a set of functional abstraction layers provided by cloud computing environment 1250 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1260 includes hardware and software components. Examples of hardware components include: mainframes 1261; RISC (Reduced Instruction Set Computer) architecture based servers 1262; servers 1263; blade servers 1264; storage devices 1265; and networks and networking components 1266. In some embodiments, software components include network application server software 1267 and database software 1268.

Virtualization layer 1270 provides an abstraction layer from which the following examples of virtual entities may be provided: virtual servers 1271; virtual storage 1272; virtual networks 1273, including virtual private networks; virtual applications and operating systems 1274; and virtual clients 1275.

In one example, management layer 1280 may provide the functions described below. Resource provisioning 1281 provides dynamic procurement of computing resources and other resources that are utilized to perform tasks within the cloud computing environment. Metering and Pricing 1282 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1283 provides access to the cloud computing environment for consumers and system administrators. Service level management 1284 provides cloud computing resource allocation and management such that required service levels are met. Service Level Agreement (SLA) planning and fulfilment 1285 provide pre-arrangement for, and procurement of, cloud computing resources for which a future requirement is anticipated in accordance with an SLA.

Workloads layer 1290 provides examples of functionality for which the cloud computing environment may be utilized. Examples of workloads and functions which may be provided from this layer include mapping and navigation 1291; software development and lifecycle management 1292; virtual classroom education delivery 1293; data analytics processing 1294; transaction processing 1295; and assessing conditions and recommending modifications 1296.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for prioritizing queued tasks waiting to access a resource associated with a resource manager in an application server, wherein an incoming task received at the application server from a calling application includes a status indicating that the incoming task is in a final phase during which a response to the calling application is created, the method comprising:
receiving the incoming task;
identifying the status of the incoming task;
in response to identifying that the status of the incoming task is in the final phase, placing the incoming task in a priority queue;
analyzing any queued tasks waiting to access the resource in the priority queue and one or more other queues; and
processing a queued task from the priority queue in preference to the one or more other queues.

2. The method of claim 1, wherein the incoming task comprises the status indicating that the incoming task in another phase.

3. The method of claim 2 further comprising:
in response to identifying that the status of the incoming task is in the another phase, placing the incoming task in one of the one or more other queues.

4. The method of claim 1, wherein the application server further comprises a resource flow processor for monitoring the state of the incoming task; and
wherein the method further comprises marking the incoming task according to a processing phase.

5. The method of claim 1, wherein the application server further comprises a thread pool for managing and allocating the processing of the incoming task.

6. The method of claim 1, wherein the incoming task and the queued task that is processed from the priority queue are identical.

7. The method of claim 1, wherein the incoming task and the queued task that is processed from the priority queue are different.

8. The method of claim 1, wherein the final phase of the incoming task denotes when the incoming task has completed a business logic processing phase.

9. The method of claim 1, wherein the processing the queued task includes allocating the resource associated with the resource manager.

10. A system for prioritizing queued tasks waiting to access a resource associated with a resource manager in an application server, wherein an incoming task received at the application server from a calling application includes a status indicating that the incoming task is in a final phase during which a response to the calling application is created, the system comprising:
a task queue;
a thread pool;
a resource flow processor; and
at least one resource manager for managing communication between the application server and a resource,
a processing device; and
a memory coupled to the processing device and storing instructions that, when executed by the processing device, cause the system to perform operations comprising:
receiving the incoming task;
identifying the status of the incoming task;
in response to identifying that the status of the incoming task is in the final phase, placing the incoming task in a priority queue;
analyzing any queued tasks waiting to access the resource in the priority queue and one or more other queues; and
processing a queued task from the priority queue in preference to the one or more other queues.

11. The system of claim 10, wherein the incoming task includes the status indicating that the incoming task in another phase.

12. The system of claim 11, wherein the operations further comprises:
in response to identifying that the status of the incoming task is in the another phase, placing the incoming task in one of the one or more other queues.

13. The system of claim 10, wherein the operations further comprises:
marking the incoming task according to a processing phase.

14. The system of claim 10, wherein the thread pool manages and allocates the processing of the incoming task.

15. The system of claim 10, wherein the incoming task and the queued task are identical.

16. The system of claim 10, wherein the incoming task and the queued task are different.

17. The system of claim 10, wherein the final phase of the incoming task denotes when the incoming task has completed a business logic processing phase.

18. The system of claim 10, wherein the processing the queued task includes allocating the resource associated with the resource manager.

19. A computer program product for prioritizing queued tasks waiting to access a resource associated with a resource manager in an application server, wherein an incoming task received at the application server from a calling application includes a status indicating that the incoming task is in a final phase during which a response to the calling application is created, the computer program product comprising:
a computer readable storage medium readable by a processing circuit and storing instructions for execution by the processing circuit for performing a method comprising:
receiving the incoming task;
identifying the status of the incoming task;
in response to identifying that the status of the incoming task is in the final phase, placing the incoming task in a priority queue;
analyzing any queued tasks waiting to access the resource in the priority queue and one or more other queues; and
processing a queued task from the priority queue in preference to the one or more other queues.
